(19) United States
(12) Patent Application Publication
(10) Pub. No.: US 2025/0136385 A1
(43) Pub. Date: May 1, 2025

(54) SYSTEMS AND METHODS FOR PROCESSING OBJECTS INCLUDING PAYLOAD STABILITY ANALYSIS SYSTEMS

(71) Applicant: Berkshire Grey Operating Company, Inc., Bedford, MA (US)

(72) Inventors: Abhishek RAJA, Medford, MA (US); Michael Coreth REILLY, Brighton, MA (US); Jacob TORREY, Newton, MA (US); Kartik Suchindra BABU, Bremerton, WA (US); Geordie Charles FOLINAS, Watertown, MA (US)

(21) Appl. No.: 18/924,068

(22) Filed: Oct. 23, 2024

Related U.S. Application Data
(60) Provisional application No. 63/545,886, filed on Oct. 26, 2023.

(51) Int. Cl. B65G 43/08; B65G 15/42; B65G 41/00

(52) U.S. Cl. CPC B65G 43/08; B65G 15/42; B65G 41/003; B65G 2203/0225

(57) ABSTRACT

An object processing system is disclosed that includes a carrier for receiving an object on a receiving surface thereof, said receiving surface being adapted to move the object thereon in at least one transfer direction; a horizontal translation system for moving the carrier in a horizontal direction that is generally orthogonal to the transfer direction; a vertical translation system for moving the carrier in a vertical direction; and a payload stability system including a plurality of emitters that each emit a detectable field over a portion of the receiving surface, and a plurality of receivers for receiving the detectable field from each of the plurality of emitters and providing a plurality of detection signals, said payload stability system providing payload stability information responsive to the plurality of detection signals.

### PRIORITY

The present application claims priority to U.S. Provisional Patent Application No. 63/545,886 filed Oct. 26, 2023, the disclosure of which is hereby incorporated by reference in its entirety.

### BACKGROUND

The invention generally relates to object processing systems, and relates in particular to object processing systems such as automated storage and retrieval systems, distribution center systems, and sortation systems that are used for processing a variety of objects.

Current object processing systems generally involve the processing of a large number of objects, where the objects are received in either organized or disorganized batches, and must be routed to desired destinations in accordance with a manifest or specific addresses on the objects (e.g., in a mailing/delivery system).

Automated storage and retrieval systems (AS/RS), for example, generally include computer-controlled systems for automatically storing (placing) and retrieving items from defined storage locations. Traditional AS/RS typically employ totes (or bins), which are the smallest unit of load for the system. In these systems, the totes are brought to people who pick individual items out of the totes. When a person has picked the required number of items out of the tote, the tote is then re-inducted back into the AS/RS.

Current distribution center sorting systems, for example, generally assume an inflexible sequence of operations whereby a disorganized stream of input objects is first singulated into a single stream of isolated objects presented one at a time to a scanner that identifies the object. An induction element (e.g., a conveyor, a tilt tray, or manually movable bins) transport the objects to the desired destination or further processing station, which may be a bin, an inclined shelf, a chute, a bag or a conveyor, etc.

In parcel sortation systems, human workers or automated systems typically retrieve parcels in an arrival order, and sort each parcel or object into a collection bin based on a set of given heuristics. For instance, all objects of like type might go to a collection bin, or all objects in a single customer order, or all objects destined for the same shipping destination, etc. The human workers or automated systems are required to receive objects and to move each to their assigned collection bin. If the number of different types of input (received) objects is large, a large number of collection bins is required.

Current state-of-the-art sortation systems rely on human labor to some extent. Most solutions rely on a worker that is performing sortation, by scanning an object from an induction area (chute, table, etc.) and placing the object in a staging location, conveyor, or collection bin. When a bin is full or the controlling software system determines that it needs to be emptied, another worker empties the bin into a bag, box, or other container, and sends that container on to the next processing step. Such a system has limits on throughput (i.e., how fast can human workers sort to or empty bins in this fashion) and on number of diverts (i.e., for a given bin size, only so many bins may be arranged to be within efficient reach of human workers).

Adding to these challenges are the conditions that some objects may have information about the object entered into the manifest or a shipping label incorrectly. For example, if a manifest in a distribution center includes a size or weight for an object that is not correct (e.g., because it was entered manually incorrectly), or if a shipping sender enters an incorrect size or weight on a shipping label, the processing system may reject the object as being unknown. Additionally, and with regard to incorrect information on a shipping label, the sender may have been undercharged due to the erroneous information, for example, if the size or weight was entered incorrectly by the sender.

There remains a need for a more efficient and more cost-effective object processing systems that process objects of a variety of sizes and weights into appropriate collection bins or boxes, yet is efficient in handling objects of such varying sizes and weights.

### SUMMARY

In accordance with an aspect, the invention provides an object processing system that includes a carrier for receiving an object on a receiving surface thereof, the receiving surface being adapted to move the object thereon in at least one transfer direction; a horizontal translation system for moving the carrier in a horizontal direction that is generally orthogonal to the transfer direction; a vertical translation system for moving the carrier in a vertical direction; and a payload stability system including a plurality of emitters that each emit a detectable field over a portion of the receiving surface, and a plurality of receivers for receiving the detectable field from each of the plurality of emitters and providing a plurality of detection signals, said payload stability system providing payload stability information responsive to the plurality of detection signals.

In accordance with another aspect, the invention provides a carrier for use in an object processing system. The carrier includes a receiving surface for receiving an object thereon, the receiving surface being adapted to move the object thereon in at least one transfer direction, a mounting adapted to be engaged by each of a horizontal translation system for moving the carrier in a horizontal direction and a vertical translation system for moving the carrier in a vertical direction, and a payload stability system including a plurality of emitters that each emit a detectable field over a portion of the receiving surface, and a plurality of receivers for receiving the detectable field from each of the plurality of emitters and providing a plurality of detection signals, said payload stability system providing payload stability information responsive to the plurality of detection signals.

In accordance with a further aspect, the invention provides a method of processing objects that includes receiving an object on a receiving surface of a carrier, the receiving surface being adapted to move the object thereon in at least one transfer direction, moving the carrier in a horizontal direction that is generally orthogonal to the transfer direction, moving the carrier in a vertical direction, emitting a plurality of detectable fields from a plurality of emitters that emit each of the plurality of detectable fields over a portion of the receiving surface, receiving the plurality of detectable fields from the plurality of emitters at a plurality of receivers, and providing payload stability information responsive to the plurality of detection signals

### BRIEF DESCRIPTION OF THE DRAWINGS

The following description may be further understood with reference to the accompanying drawings in which;

FIG. 1 shows an illustrative diagrammatic view of an object processing system in accordance with an aspect of the present invention;

FIG. 2 shows an illustrative diagrammatic end view of the system of FIG. 1;

FIG. 3 shows an illustrative diagrammatic end view of an object processing system that includes a programmable motion device at the induction area;

FIG. 4 shows an illustrative diagrammatic end view of an object processing system in accordance with an aspect of the present invention;

FIG. 5 shows an illustrative diagrammatic enlarged side view of the system of FIG. 1 with the carrier having moved toward the destination locations;

FIG. 6 shows an illustrative diagrammatic view of the horizontal gantry system of the system of FIG. 1;

FIG. 7 shows an illustrative diagrammatic view of the carrier of FIG. 1 moving an object into a destination location;

FIG. 8 shows an illustrative diagrammatic view of the vertical gantry system of the system of FIG. 1;

FIG. 9 shows an illustrative diagrammatic elevated side view of the vertical gantry system of FIG. 8;

FIG. 10 shows an illustrative diagrammatic view of a portion of the carrier of FIG. 1 showing one of a plurality of emitters engaged to emit a detectable field;

FIG. 11 shows an illustrative diagrammatic opposite side view of the portion of the carrier of FIG. 1 showing the a receiver for detecting the one of the plurality of emitter engaged to emit the detectable field;

FIG. 12 shows an illustrative diagrammatic side view of the carrier of FIG. 1 showing a plurality of emitters engaged to emit a detectable field;

FIG. 13 shows an illustrative diagrammatic side view of the carrier and plurality of engaged emitters of FIG. 12 from an opposite side;

FIG. 14 shows an illustrative diagrammatic side view of the carrier of FIG. 1 showing a plurality of emitters engaged to emit a detectable field with respect to another object;

FIG. 15 shows an illustrative diagrammatic side view of the carrier of FIG. 1 showing a plurality of emitters engaged to emit a detectable field with respect the object of FIG. 14 having rolled backward;

FIG. 16 shows an illustrative diagrammatic view of a carrier loading system in accordance with an aspect of the present invention that includes a stationary back-wall;

FIG. 17 shows an illustrative diagrammatic underside end view of the system of FIG. 1; and

FIGS. 18A-18C show illustrative diagrammatic functional views of a flow chart showing operational steps of a system in accordance with an aspect of the present invention.

The drawings are shown for illustrative purposes only.

### DETAILED DESCRIPTION

Systems and methods of the invention maybe used in the context of a robotic put wall or other sorting systems employing a payload carrier with a lateral degree of freedom. Some payloads may be unstable on the carrier, and/or the payload may shift (e.g., bounce or roll) too close to the edges of the payload carrier. In accordance with various aspects, the invention provides systems and methods that employ sensors, programming and techniques for centering a payload on a carrier so that the carrier may properly deliver its payload to the appropriate destination location (e.g., cubbies, bins, totes, etc.).

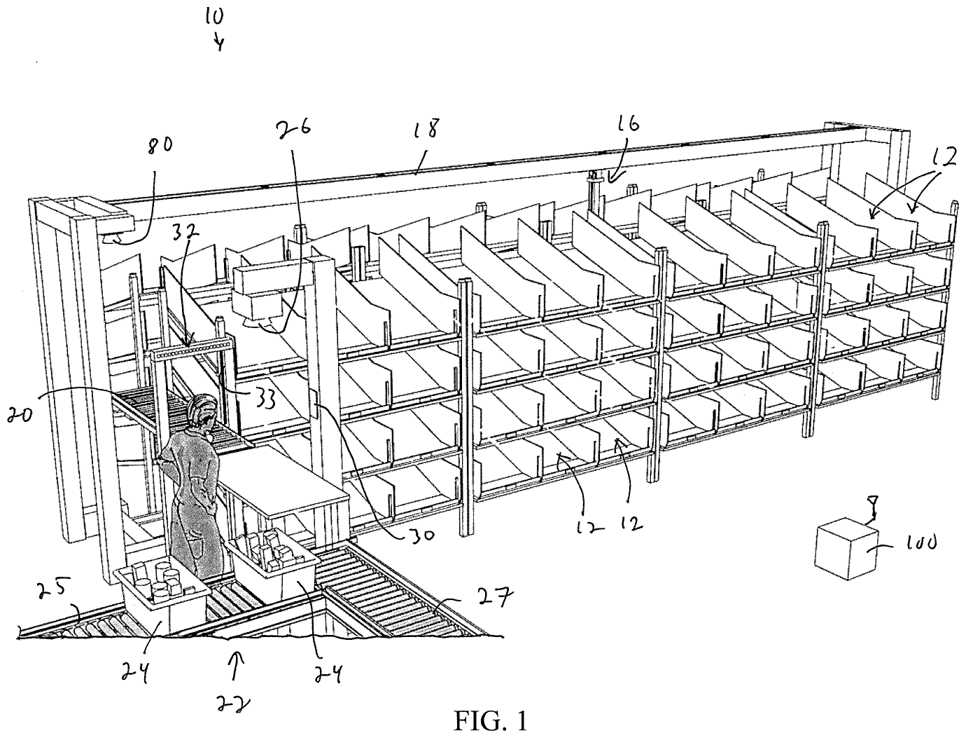

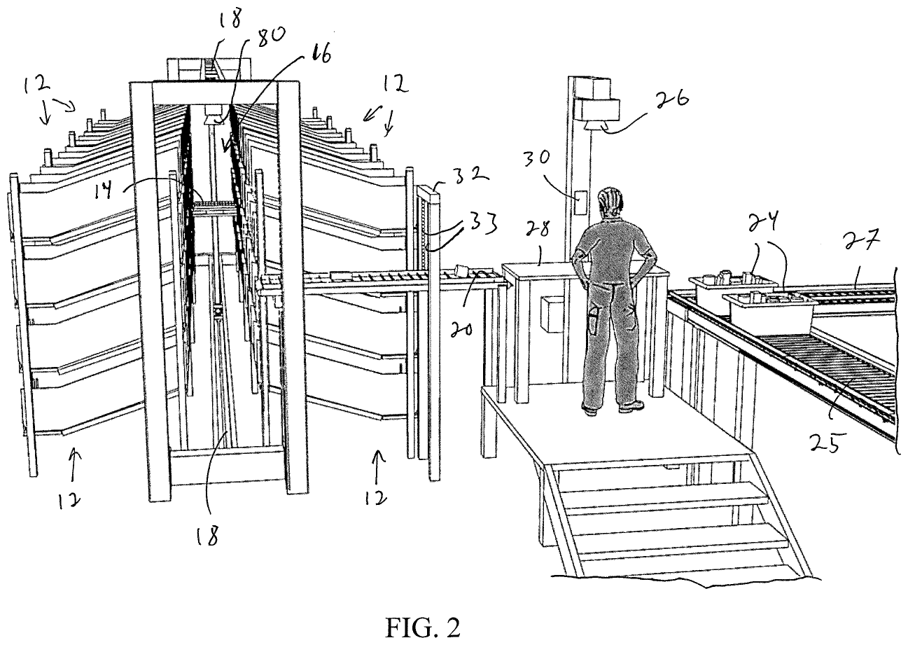

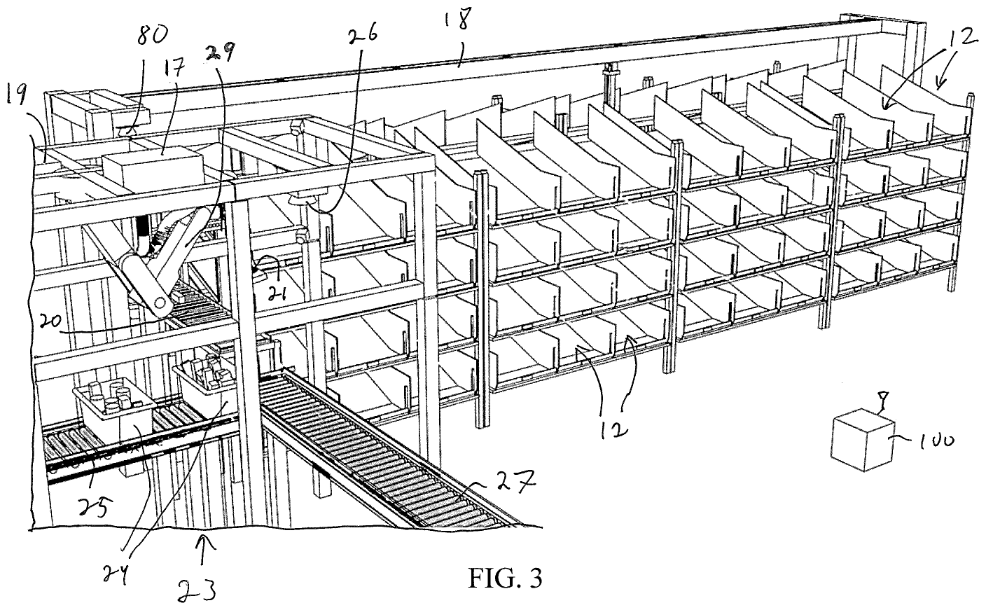

FIG. 1, for example, shows an object processing system 10 that includes a plurality of destination locations 12, the upper end of each of which may be accessed by a carrier 14 (shown in FIG. 2) mounted on a vertical gantry system 16 that travels along upper and lower horizontal gantry beams 18. The carrier 14 may be positioned at a distal end of an infeed conveyor 20 that receives objects from either an automated programmable motion device (as shown in FIG. 3) or a human personnel station 22 as shown in FIG. 1. Objects, for example, may be provided in bins 24 on an input conveyor 25. Each object may be scanned by a perception system 26 (which may further include perception units in the table 28 facing upward), and the empty bins may be taken away by a bin takeaway conveyor 27. The human personnel may check via a monitor 30 that the object has properly scanned, and may place the object onto the infeed conveyor 20 when the illuminated frame 32 indicates that the system is ready to receive a next object (e.g., by turning from red to green). The illuminated frame 32 may further include object detection pairs 33 on either of the inner sides of vertical portions of the frame as shown in FIG. 2 for detecting/confirming the presence of an object on the conveyor 20, and for providing size information regarding a size of each object. This size information may be used to confirm the identity of the object, and to permit the system to ready the carrier 14 to best receive the object.

As each object is scanned, the appropriate destination for the object location is identified, and its order of being fed toward the carrier 14 is noted so that it may be properly routed while other previously scanned objects are individually routed to their assigned destination locations. FIG. 2 shows an end view of the system showing the vertical gantry system 16 mounted on the horizontal system rails 18. The system maintains the order of entry of each object noting the assigned destination location for each object as they are fed into the infeed conveyor 20. Operation of the components of the system, including the conveyors, the vertical and horizontal translation systems, the carrier conveyor and any programmable motion device may be governed by one or more computer processing systems 100.

FIG. 3 shows an object processing system in accordance with another aspect of the present invention that includes a programmable motion device at the induction area in place of the human personnel station 22 of FIG. 1. In particular FIG. 3 shows an object processing system 11 that includes a plurality of destination locations 12, the upper end of each of which may be accessed by a carrier 14 (again shown in FIG. 2) mounted on a vertical gantry system 16 that travels along upper and lower horizontal gantry beams 18. The carrier 14 may be positioned at a distal end of an infeed conveyor 20 that receives objects from a programmable motion device 29 at an automated station 23. The programmable motion device 29 uses an end-effector 21 to move objects from the input bins 24 on input conveyor 25. Each object may be scanned by the perception system 26, and the empty bins may be taken away by the bin takeaway conveyor 27. The programmable motion device 29 may place the object onto the infeed conveyor 20 when the system is ready to receive a next object. The illuminated frame 32 may further include object detection pairs 33 on either of the inner sides of vertical portions of the frame as shown in FIG. 2 for detecting/confirming the presence of an object on the conveyor 20, and for providing size information regarding a size of each object. This size information may be used to confirm the identity of the object, and to permit the system to ready the carrier 14 to best receive the object. The end-effector may be a vacuum cup end-effector that is coupled to a vacuum source 17, and the programmable motion device 29 may be operated by one or more computer processing systems 19.

FIG. 4 shows an enlarged elevational end view of the carrier 14 having just received an object 32 from the infeed conveyor 20. FIG. 4 also shows the vertical gantry system 16 mounted on the lower rail 18. The movement of the vertical gantry 16 along the lower rail 18 (as well as the upper rail not shown in FIG. 4) is accomplished by a horizontal movement motor 34. The movement of the carrier along the vertical gantry 16 is accomplished by the vertical movement motor 36, and the movement of the object receiving surface 38 in either of two mutually opposing directions toward the destination locations 12 is accomplished by the carrier conveyor motor 40. Note that only the carrier conveyor motor 40 travels with the carrier 14 reducing the load on the carrier itself.

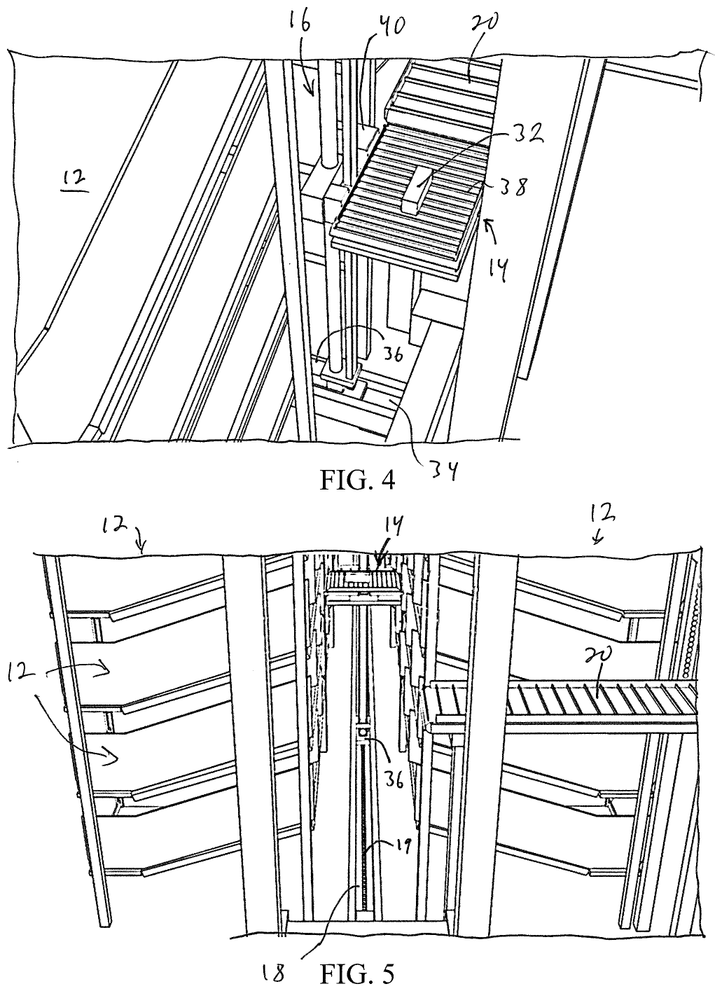

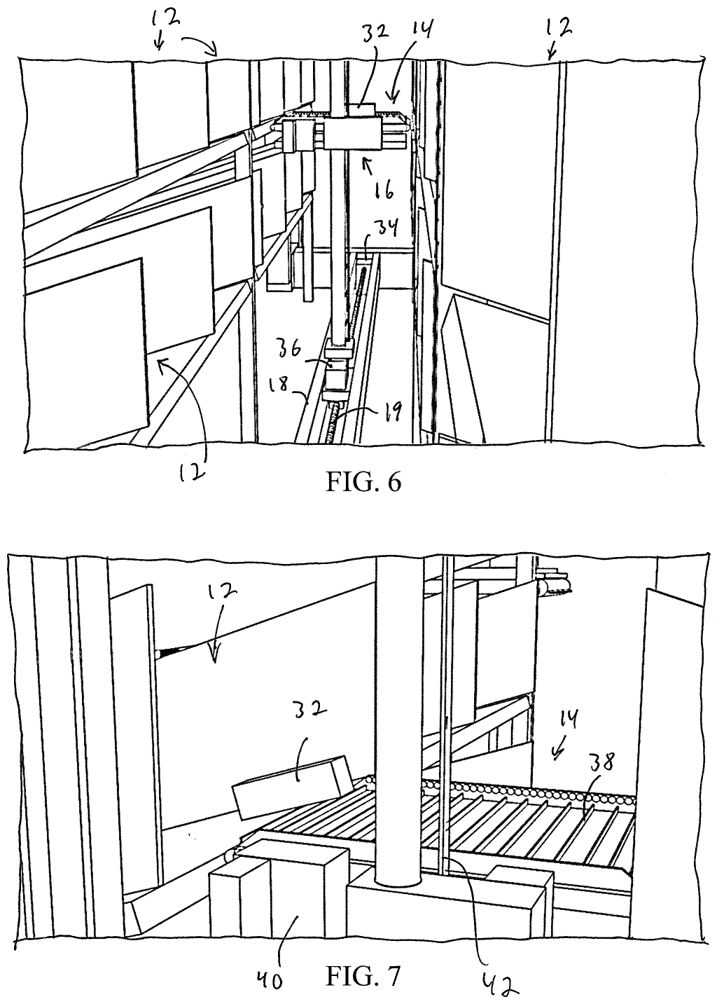

With reference to FIG. 5, the horizontal movement motor 34 may be actuated to move the carrier 14 and the vertical gantry system 16 along the rails 18 toward the selected destination location. The horizontal movement system may, for example, employ a screw drive system or a ball screw system in which the base of the vertical gantry system 16 (as well as the top of the vertical gantry system) travels along a rotating turn screw 19 (as also shown in FIGS. 6 and 9). Separately or at the same time, the vertical movement motor 36 may be actuated to move the carrier upward or downward toward the selected destination location as shown in FIG. 6. The vertical movement of the carrier may be actuated by a belt (or chain) drive in combination with a stabilizing block as discussed below, or may employ a screw drive system or ball screw system as discussed above with reference to the horizontal movement system. Once the carrier 14 has arrived at the selected destination location, the carrier conveyor motor 40 may be actuated (in either direction) to move the object 32 on the carrier 14 into the selected destination location as shown in FIG. 7.

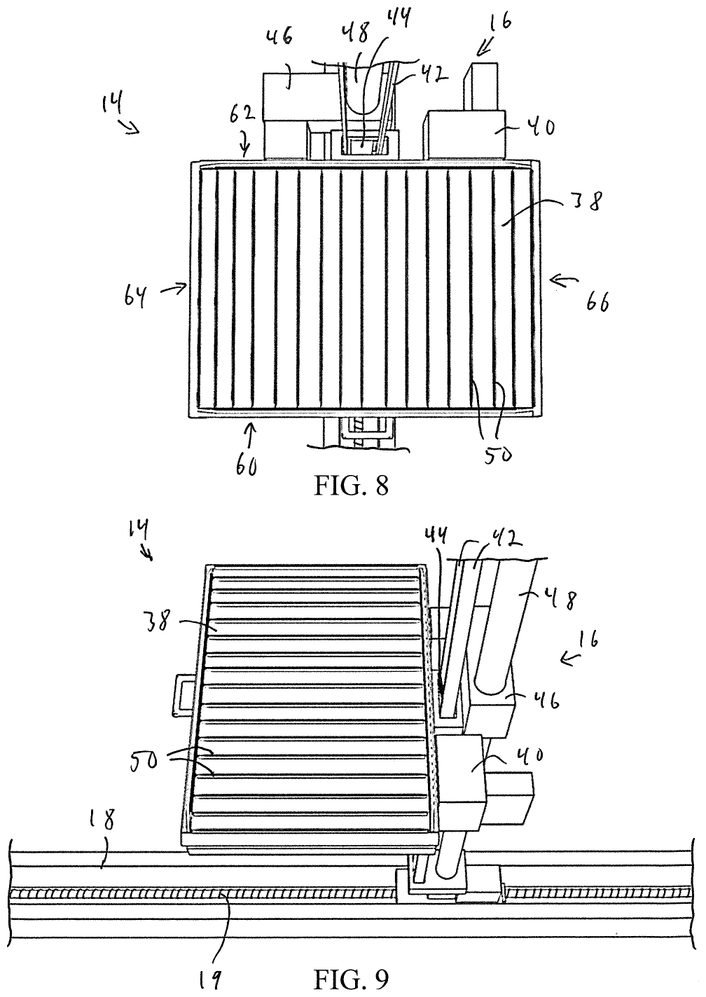

FIG. 8 shows the vertical gantry system 16 including a belt 42 (or chain) that is attached on one side to the carrier 14 as shown at 44 as shown. A stabilizing block 46 attached to the carrier also rides along a vertical rod 48 to facilitate stabilizing the carrier 14 as it travels up and down the vertical gantry system. FIG. 8 also shows at 60 the proximal end of the carrier, shows at 62 the distal end of the carrier, shows at 64 a first side of the carrier and shows at 66 an opposite second side of the carrier. The attachment 44 and the stabilizing block are further shown in the elevated side view of FIG. 9. The cleats 50 on the receiving surface 38 may be mutually spaced by a distance that is smaller than a smallest dimension of most the objects to be processed such that most or all objects ride on at least one cleat 50. When cleats are used therefore, the receiving surface 38 may include uniformly or non-uniformly spaced cleats 50. FIG. 9 also shows the attachment 44 between the carrier 14 and one side of the belt 42, as well as the rotating turn screw 19 in the lower horizontal gantry beam rail 18. Each of the horizontal movement motor 34 and the vertical movement motor 36 may be engageable in a low friction neutral mode in which the carrier may be readily moved for repositioning by human personal as may be needed.

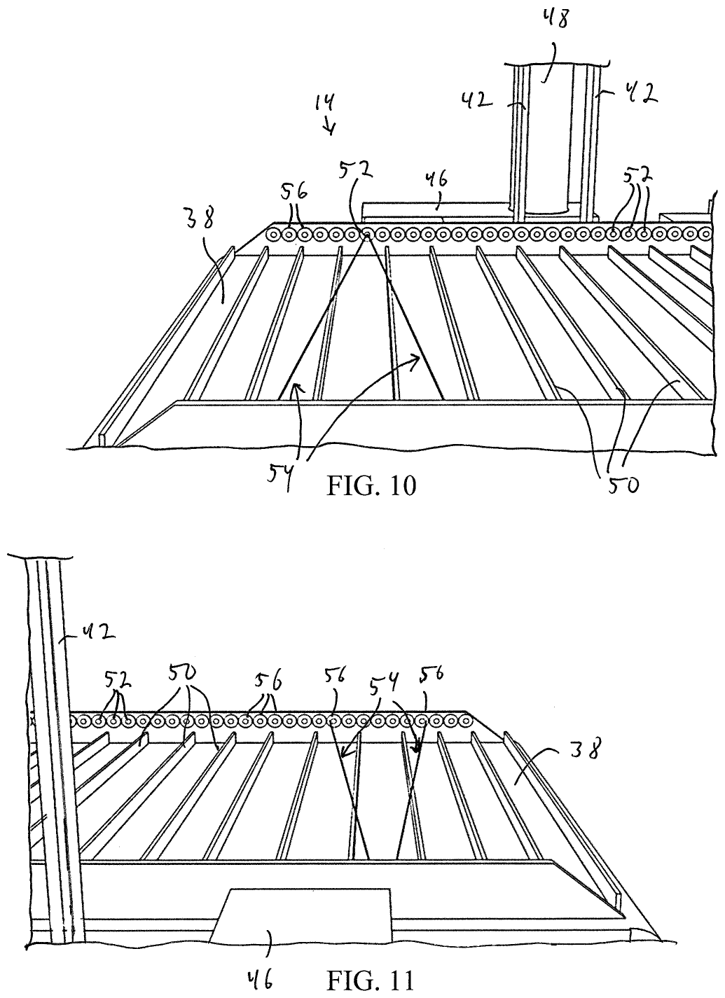

FIG. 10 shows an enlarged view of a portion of the carrier 14 showing one of a plurality of emitters 52 engaged to emit a detectable field 54. The field 54 may be either divergent or collimated, and each of the emitters 52 may be associated with one or more detectors 56. Both ends of the carrier 14 may include combined emitter-detector sets, with each emitter 52 being positioned within a ring of detectors 56 as further shown in FIG. 11. The system may engage each emitter separately and for each emitter map the detected fields at the plurality of detectors 56. The system may therefore quickly determine where the field from each emitter is detected. Alternately, each emitter may emit a different detectable field at, for example, a different frequency and each emitter may determine the frequency of the detected field, permitting all emitters to be engaged concurrently.

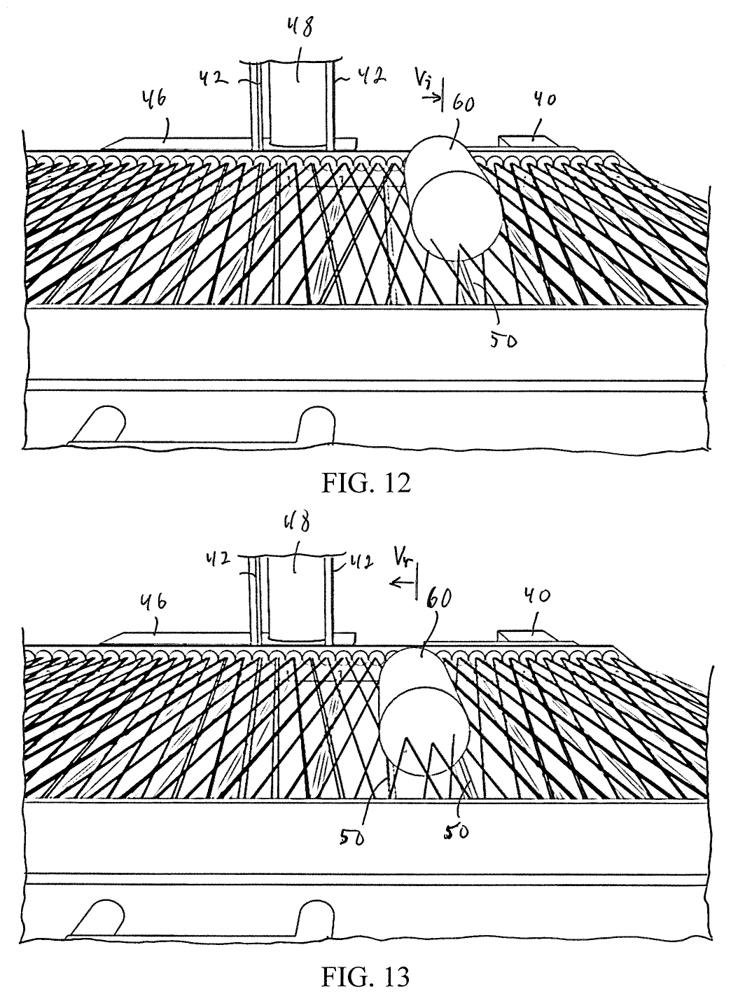

The system initially maps where each detectable field from each emitter is expected to be received with no object on the carrier 14. Then, when an object is present in the carrier the system will evaluate where signals that were expected are not present. Using this information, the system may not only detect where a static object is positioned on the carrier but also may determine a velocity of movement of a centerline of an object on the carrier. For example, FIG. 12 shows diagrammatically an object 60 moving on the receiving surface wherein a centerline of the object is determined and the center of mass is determined to be moving at a velocity of Vi. The object may come to a stop on a cleat 50 as shown, and may roll back (Vr) to a resting position between cleat 50 as shown in FIG. 13.

In accordance with certain aspects therefore the system employs cross patterns of beam of light or infrared illumination as well as individual beam/receiver status information. The block-beam status may be used to calculate a centerline of an object on the receiving surface 38 as well as a velocity of the centerline of the object as it moves across the receiving surface 38 by monitoring the absolute rate of change of the centerline. For example, an object may be inducted with an initial velocity (e.g., 500 mm/s), and when the absolute object velocity drops below a threshold velocity (e.g., 350 mm/s) for a minimum period of time (e.g., 75 ms) the object may be considered to have settled.

Once the object is determined to have met the condition for settling (below a threshold velocity for a minimum period of time), the system determines a distance between the object centerline and the center of the receiving surface 38. If the absolute centerline to receiving surface centerline is above an off-center threshold distance (e.g., 150 mm) the gantry dwells and centering begins immediately. Gantry movement begins as soon as the distance between the object centerline and the center of the receiving surface 38 is below the off-center threshold (e.g., again, 150 mm). Centering may still occur after the gantry has begun to move (regardless of whether the distance between the object centerline and the center of the receiving surface 38 was initially greater than the off-center threshold distance).

The centering may involve engaging the carrier conveyor motor 40 to move the conveyor such that the object becomes more centered if the object is closer to one or the other of the first side 64 or second side 66 (as shown in FIG. 8). This may be done while the carrier is moving along the gantry if the object is sufficiently close to the center and not moving too quickly as discussed above.

The system may also determine from the cross-pattern fields 54 whether an object on the carrier is too close to either the proximal end 60 or the distal end 62 of the carrier (as shown in FIG. 8). If the object is too close to the distal end 62 of the carrier, the system may engage the horizontal movement motor 34 with a short jerk to urge the object back toward a center of the receiving surface. Similarly if the object is too close to the proximal end 60 of the carrier, the system may engage the horizontal movement motor 34 with a short rearward jerk to urge the object toward the center of the receiving surface. If the object does not move as desired, the above may be repeated in combination with an engagement of the vertical movement motor 36 to provided concurrent downward jerk of the carrier so that the combination of the horizontal and vertical jerk movements may urge the object toward the center of the receiving surface.

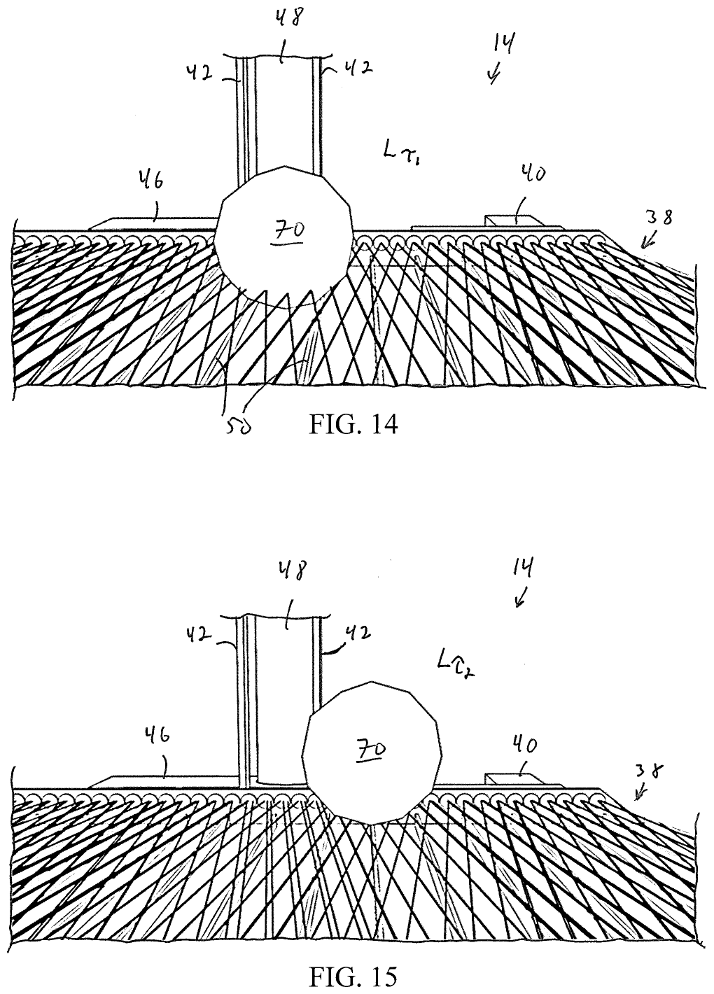

In accordance with further aspects, an object length may also be determined and any rate of change of the object length may be indicative of instability. For example, FIG. 14 shows an object 70 on a receiving surface 38 that is determined to have an object length Lt₁ at a time ti based on the blocked beams of the cross-pattern of beams. At a late time however, the object 70 is determined to have a very different length of Lt₂ as shown in FIG. 15. This is because the object 70 bounced. Information that an object has bounced may be very valuable and may be determined by monitoring whether an object's rate of change of length is negative. This may also be done concurrently with monitoring the velocity of the centerline of the object as discussed above.

Using the change in length (e.g., a negative change in length) and/or change in velocity of centerline before, during or after gantry translation, the system may determine whether an object is bouncing or rolling on the receiving surface. The object may be assigned a designation of stable or unstable (or a stability ranking), and the gantry translation and conveyor ejection parameters may be adjusted accordingly to ensure that the object is properly routed to and ejected into the destination location efficiently without adverse events. The system may, for example, slow down the gantry movements where an object is determined to be particularly unstable.

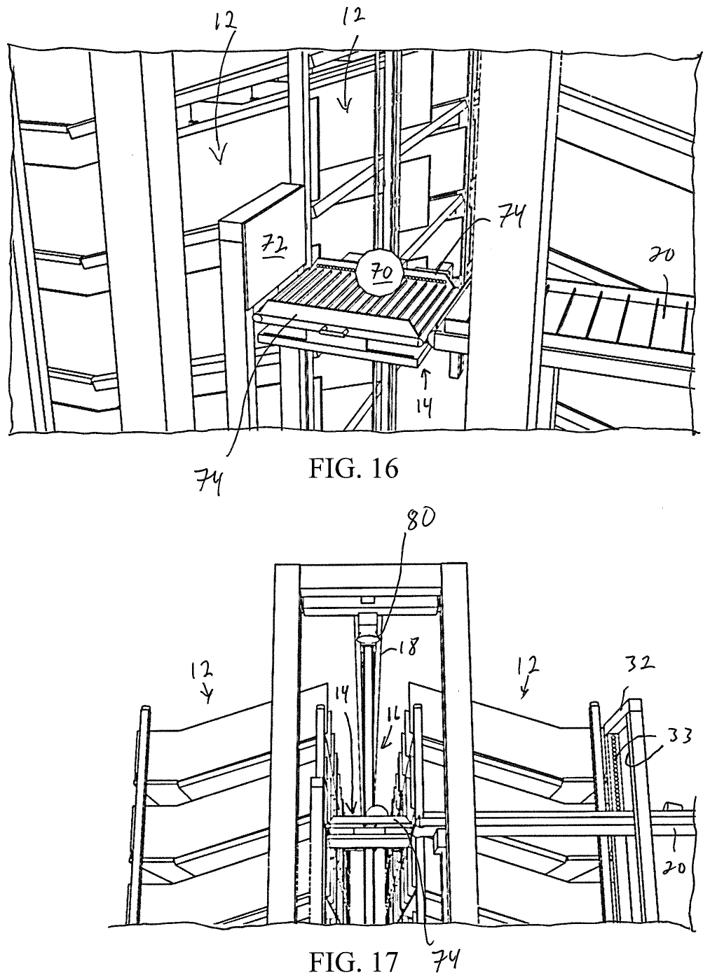

In accordance with further aspects, systems of certain aspects of the present invention may further include a stationary back-wall 72 that may facilitate containing a particularly unstable object, as well as higher proximal and distal end walls 74 as shown in FIG. 16. Additionally, systems of certain aspects of the present invention may further include a perception system 80 that provides perception data regarding movement of each object on the carrier 14 during loading as shown in FIG. 17. This perception data may be accessed and evaluated in the event that the above system employing the cross-patterns of beams is unable to provide sufficient stabilization of particular outlier objects.

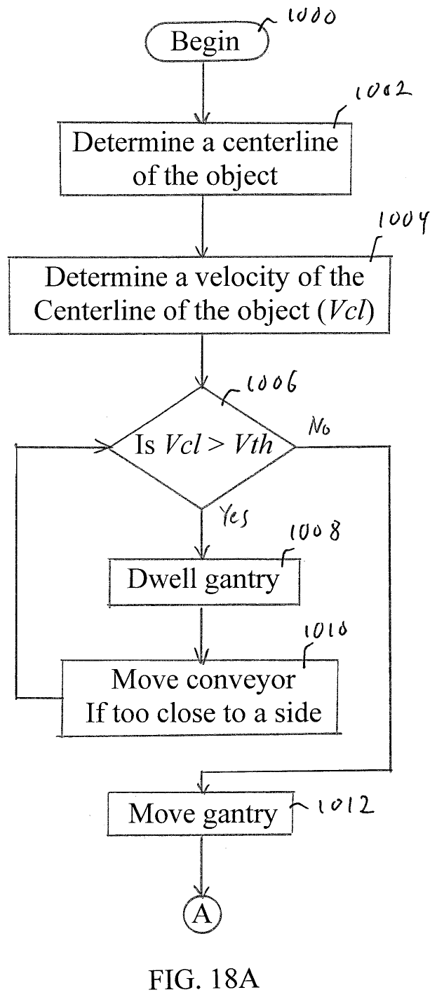

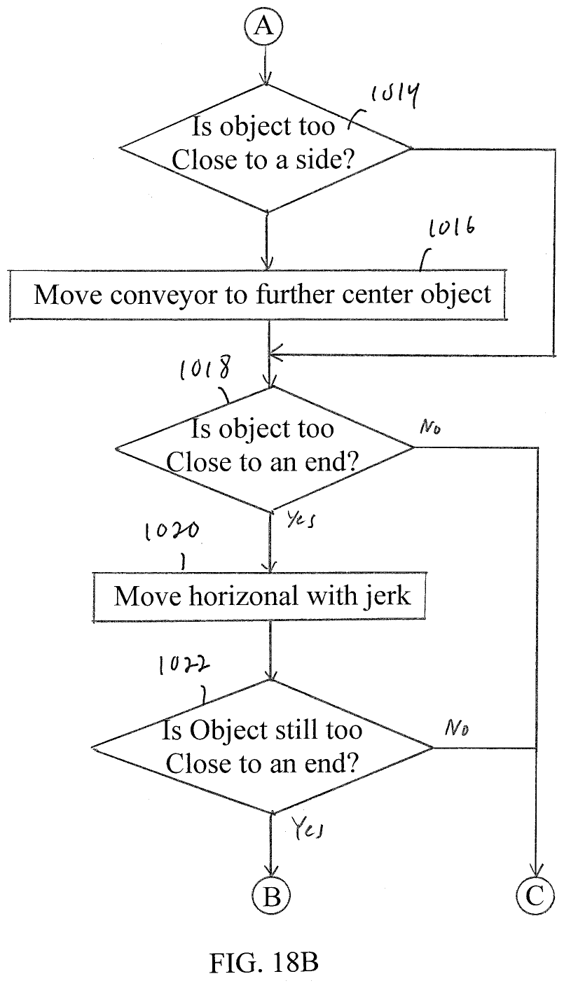

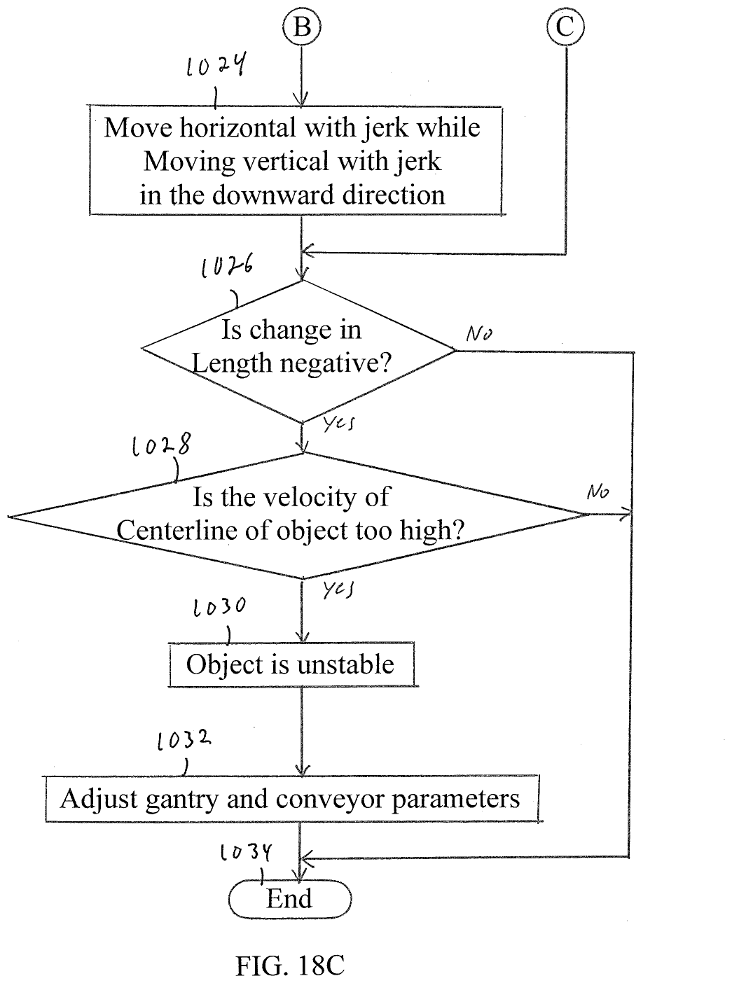

With reference to FIG. 18A, therefore, the system provides in certain aspects that when an object is loaded onto the carrier, a process begins (step 1000) by determining a centerline of the object (step 1002) and determining a velocity of a centerline of the object (step 1004). The system then determines whether the velocity of a centerline of the object is greater than a threshold velocity (step 1006) and if so, the system will temporarily dwell the gantry (step 1008). The system then will move the conveyor if the object is too close to a side of the conveyor (step 1010). The process continues until the velocity of the centerline of the object is not greater than a threshold velocity (step 1006), at which time the gantry is engaged to move (step 1012).

With reference to FIG. 18B, the system then determines whether the object is still too close to a side (step 1014) and if so, the system will move the conveyor to further center the object on the carrier (step 1016). The system will next determine whether the object is too close to an end of the carrier (step 1018). If so, the system will first move the carrier horizontally with a jerk (step 1020), and if the object is still too close to an end (step 1022) the system will move the carrier with horizontal jerk and a vertical downward jerk (step 1024) as presented in FIG. 18C. The system will then determine whether there exists any change in the length of the object (e.g., as the object moves through the cross-pattern of beams) and if such a change is negative (step 1026) or the velocity of the centerline of the object remains too high (step 1028), the system will flag that the object is unstable (step 1030) and will adjust the gantry and conveyor parameters accordingly (step 1032), e.g., by slowing down the movements, prior to ending (step 1034).

Those skilled in the art will appreciate that numerous modifications and variations may be made to the above disclosed embodiments without departing from the spirit and scope of the present invention;

1. An object processing system comprising:
a carrier for receiving an object on a receiving surface thereof, said receiving surface being adapted to move the object thereon in at least one transfer direction,
a horizontal translation system for moving the carrier in a horizontal direction that is generally orthogonal to the transfer direction,
a vertical translation system for moving the carrier in a vertical direction, and
a payload stability system including a plurality of emitters that each emit a detectable field over a portion of the receiving surface, and a plurality of receivers for receiving the detectable field from each of the plurality of emitters and providing a plurality of detection signals, said payload stability system providing payload stability information responsive to the plurality of detection signals.

2. The object processing system as claimed in claim 1, wherein the receiving surface includes a cleated conveyor for facilitating transfer of the object off of the carrier in the transfer direction.

3. The object processing system as claimed in claim 2, wherein the transfer direction is one of two mutually opposing directions in which the object may be transferred by the cleated conveyor.

4. The object processing system as claimed in claim 1, wherein the carrier is fed from an infeed conveyor.

5. The object processing system as claimed in claim 1, wherein the payload stability information includes information regarding whether a non-centered object thereon is rolling on the carrier.

6. The object processing system as claimed in claim 1, wherein the payload stability information includes information regarding whether a non-centered object thereon is bouncing on the carrier.

7. The object processing system as claimed in claim 1, wherein the payload stability information includes information regarding whether a non-centered object thereon is too close to either side of the carrier.

8. The object processing system as claimed in claim 7, wherein the receiving surface of the carrier is adapted to move responsive to the payload stability information when the non-centered object is too close to a side of the receiving surface to bring the non-centered object toward a center of the carrier.

9. The object processing system as claimed in claim 1, wherein the payload stability information includes information regarding whether a non-centered object thereon is too close to either end of the carrier.

10. The object processing system as claimed in claim 9, wherein the horizontal translation system is adapted to engage the carrier responsive to the payload stability information when the non-centered object is too close to an end of the receiving surface to bring the non-centered object toward a center of the carrier.

11. The object processing system as claimed in claim 9, wherein both of the horizontal translation system and the vertical translation system are adapted to engage the carrier responsive to the payload stability information when the non-centered object is too close to an end of the receiving surface to bring the non-centered object toward a center of the carrier.

12. A carrier for use in an object processing system, said carrier comprising:
a receiving surface for receiving an object thereon, said receiving surface being adapted to move the object thereon in at least one transfer direction,
a mounting adapted to be engaged by each of a horizontal translation system for moving the carrier in a horizontal direction and a vertical translation system for moving the carrier in a vertical direction, and
a payload stability system including a plurality of emitters that each emit a detectable field over a portion of the receiving surface, and a plurality of receivers for receiving the detectable field from each of the plurality of emitters and providing a plurality of detection signals, said payload stability system providing payload stability information responsive to the plurality of detection signals.

13. The carrier as claimed in claim 12, wherein the receiving surface includes a cleated conveyor for facilitating transfer of the object off of the carrier in the transfer direction.

14. The carrier as claimed in claim 13, wherein the transfer direction is one of two mutually opposing directions in which the object may be transferred by the cleated conveyor.

15. The carrier as claimed in claim 12, wherein the carrier is fed from an infeed conveyor.

16. The carrier as claimed in claim 12, wherein the payload stability information includes information regarding whether a non-centered object thereon is rolling on the carrier.

17. The carrier as claimed in claim 12, wherein the payload stability information includes information regarding whether a non-centered object thereon is bouncing on the carrier.

18. The carrier as claimed in claim 12, wherein the payload stability information includes information regarding whether a non-centered object thereon is too close to either side of the carrier.

19. The carrier as claimed in claim 18, wherein the receiving surface of the carrier is adapted to move responsive to the payload stability information when the non-centered object is too close to a side of the receiving surface to bring the non-centered object toward a center of the carrier.

20. The carrier as claimed in claim 12, wherein the payload stability information includes information regarding whether a non-centered object thereon is too close to either end of the carrier.

21. The carrier as claimed in claim 20, wherein the horizontal translation system is adapted to engage the carrier responsive to the payload stability information when the non-centered object is too close to an end of the receiving surface to bring the non-centered object toward a center of the carrier.

22. The carrier as claimed in claim 20, wherein both the horizontal translation system and the vertical translation system are adapted to engage the carrier responsive to the payload stability information when the non-centered object is too close to an end of the receiving surface to bring the non-centered object toward a center of the carrier.

23. A method of processing objects comprising:
receiving an object on a receiving surface of a carrier, said receiving surface being adapted to move the object thereon in at least one transfer direction,
moving the carrier in a horizontal direction that is generally orthogonal to the transfer direction,
moving the carrier in a vertical direction,
emitting a plurality of detectable fields from a plurality of emitters that emit each of the plurality of detectable fields over a portion of the receiving surface;
receiving the plurality of detectable fields from the plurality of emitters at a plurality of receivers; and
providing payload stability information responsive to the plurality of detection signals.

24. The method of claim 23, wherein the receiving surface includes a cleated conveyor for facilitating transfer of the object off of the carrier in the transfer direction.

25. The method of claim 24, wherein the transfer direction is one of two mutually opposing directions in which the object may be transferred by the cleated conveyor.

26. The method of claim 23, wherein the method further includes feeding the carrier from an infeed conveyor.

27. The method of claim 23, wherein the payload stability information includes information regarding whether a non-centered object thereon is rolling on the carrier.

28. The method of claim 23, wherein the payload stability information includes information regarding whether a non-centered object thereon is bouncing on the carrier.

29. The method of claim 23, wherein the payload stability information includes information regarding whether a non-centered object thereon is too close to either side of the carrier.

30. The method of claim 29, wherein the receiving surface of the carrier is adapted to move responsive to the payload stability information when the non-centered object is too close to a side of the receiving surface to bring the non-centered object toward a center of the carrier.

31. The method of claim 23, wherein the payload stability information includes information regarding whether a non-centered object thereon is too close to either end of the carrier.

32. The method of claim 31, wherein the horizontal translation system is adapted to engage the carrier responsive to the payload stability information when the non-centered object is too close to an end of the receiving surface to bring the non-centered object toward a center of the carrier.

33. The method of claim 31, wherein both the horizontal translation system and the vertical translation system are adapted to engage the carrier responsive to the payload stability information when the non-centered object is too close to an end of the receiving surface to bring the non-centered object toward a center of the carrier.
